(19) United States
(12) Patent Application Publication
(10) Pub. No.: US 2019/0114078 A1
(43) Pub. Date: Apr. 18, 2019

(54) STORAGE DEVICE, COMPUTING SYSTEM INCLUDING STORAGE DEVICE AND OPERATING METHOD OF STORAGE DEVICE

(71) Applicant: SAMSUNG ELECTRONICS CO., LTD., SUWON-SI (KR)

(72) Inventor: SANGYOON OH, SUWON-SI (KR)

(21) Appl. No.: 15/997,052

(22) Filed: Jun. 4, 2018

(30) Foreign Application Priority Data
Oct. 18, 2017 (KR) 10-2017-0135435

(51) Int. Cl. G06F 3/06; G06N 99/00

(52) U.S. Cl. CPC G06F 3/0604; G06F 3/0679; G06F 3/0631; G06N 99/005

(57) ABSTRACT

A storage device includes a nonvolatile memory device, a controller, a processor, and a memory interface. The nonvolatile memory device includes first memory blocks to store a plurality of machine learning-based models and second memory blocks configured to store user data. The controller selects one of the machine learning-based models based on a model selection request. The processor loads model data associated with the selected model and schedules a tasks associated with the nonvolatile memory device based on the selected model. The memory interface accesses the second memory blocks of the nonvolatile memory device based on the scheduled tasks.

### CROSS-REFERENCE TO RELATED APPLICATIONS

This U.S. application claims priority under 35 U.S.C. § 119 to Korean Patent Application No. 10-2017-0135435 filed Oct. 18, 2017, in the Korean Intellectual Property Office, the disclosure of which is incorporated by reference herein in its entirety.

### BACKGROUND

### 1. Technical Field

Embodiments of the inventive concept described herein relate to a semiconductor memory, and more particularly, relate to a storage device, a computing system including the storage device, and an operating method of the storage device.

### 2. Discussion of Related Art

A storage device may include a nonvolatile memory. Since a storage device with a nonvolatile memory retains data stored therein even at power-off, the storage device can be used to store data for a long time. The storage device may be used as a main memory in various electronic devices such as a personal computer or a smartphone.

A pattern of performing data reading and writing on the storage device may vary according to data usage patterns of users and environments in which data is used. The operating performance of the storage device may vary if the pattern of performing data reading and writing on the storage devices varies.

A manufacturer of the storage device can set an algorithm for internal operations (e.g., write and read operations) thereof based on average usage patterns and use environments. However, such an algorithm fails to provide optimal operating performance for each user.

### SUMMARY

At least one embodiments of the inventive concept provides a storage device that provides an optimum operating performance to each user, a computing system including the storage device, and an operating method of the storage device.

According to an exemplary embodiment of the inventive concept, a storage device includes a nonvolatile memory device having a plurality of first memory blocks to store a plurality of machine learning-based models and a plurality of second memory blocks configured to store user data, a controller that selects one of the machine learning-based models based on a model selection request, a processor that loads model data associate with the selected model and schedules a task associated with the nonvolatile memory device based on the selected model, and a memory interface that accesses the second memory blocks of the nonvolatile memory device based on the scheduled task.

According to an exemplary embodiment, a computing system includes a host device, and a storage device. The host device includes a first controller that generates host environment information associated with the computing system, and selects a model associated with the storage device based on machine learning depending on the host environment information and sends a model selection request indicating the selected model to the storage device. The storage device includes a nonvolatile memory including memory blocks, a second controller that selects one of a plurality of machine learning-based models depending on the model selection request, and a processor that executes the selected model to access the nonvolatile memory device.

According to an exemplary embodiment of the inventive concept, an operation method of a storage device includes a controller of the storage device selecting an operating model of the storage device generated from a first machine learning operation, the controller receiving a request to access the storage device from an external host device, the controller scheduling a task to be performed on the storage device based on a second machine learning operation that considers the access request and the selected operating model, and a processor of the storage device executing the scheduled task.

### BRIEF DESCRIPTION OF THE FIGURES

The inventive concept will become apparent by describing in detail exemplary embodiments thereof with reference to the accompanying drawings.

FIG. 1 is a block diagram illustrating a computing system according to an exemplary embodiment of the inventive concept.

FIG. 2 is a flowchart illustrating an operating method of the computing system according to an exemplary embodiment of the inventive concept.

FIG. 3 is a block diagram illustrating a host device according to an exemplary embodiment of the inventive concept.

FIG. 4 is a flowchart illustrating an example in which a model classifier generates a model selection request.

FIG. 5 is a block diagram illustrating a storage device according to an exemplary embodiment of the inventive concept.

FIG. 6 shows an exemplary machine learning-based classifier which is able to be used in a model classifier, a task classifier, or a policy classifier.

FIG. 7 shows a machine learning-based classifier according to another example, which is able to be used in the model classifier, the task classifier, or the policy classifier.

FIG. 8 is a block diagram illustrating the host device according to an application of the inventive concept.

FIG. 9 is a flowchart illustrating an operating method of the computing system according to an exemplary embodiment of the inventive concept.

FIG. 10 is a block diagram illustrating the computing system according to an exemplary embodiment of the inventive concept.

FIG. 11 is a block diagram illustrating the storage device according to an application of the inventive concept.

FIG. 12 is a block diagram illustrating the storage device according to another application of the inventive concept.

### DETAILED DESCRIPTION

Below, exemplary embodiments of the inventive concept will be described clearly and in detail with reference to accompanying drawings to such an extent that one of an ordinary skill in the art can implement the inventive concept.

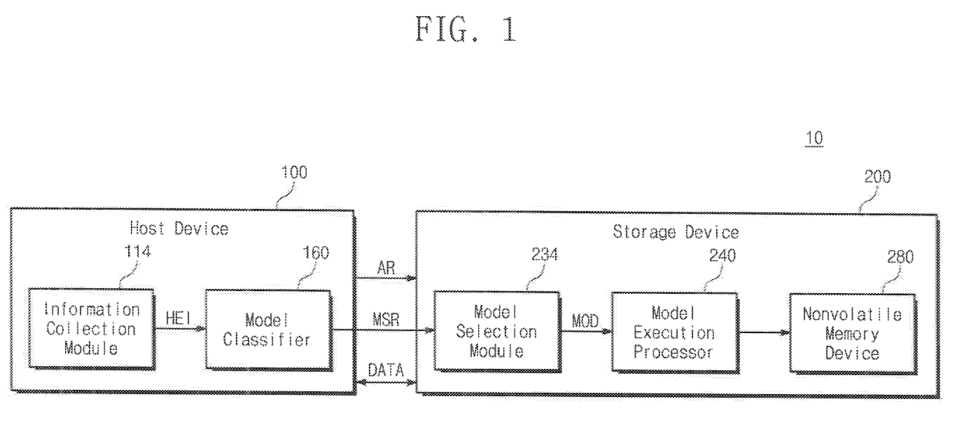

FIG. 1 is a block diagram illustrating a computing system 10 according to an exemplary embodiment of the inventive concept. Referring to FIG. 1, the computing system 10 includes a host device 100 and a storage device 200. In an embodiment, the host device 100 sends an access request AR to the storage device 200 to write data in the storage device 200 or read data from the storage device 200. The access request AR may be included within a signal sent from the host device 100 to the storage device. The access request AR may include a write command or a read command as an example.

The host device 100 includes an information collection module 114 and a model classifier 160. The information collection module 114 may collect environment information of the host device 100. For example, the information collection module 114 may collect information such as a tendency of a user using the host device 100, an access pattern of an application or process executed in the host device 100, an access pattern of memory in the host device 100, or a work load of the host device 100, and may output the collected information as host environment information HEI. For example, the workload could indicate the number of instructions being executed by a processor of the host device 100 during a given period. For example, the access pattern of the application could indicate a sequence of processes that are executed during a given period. For example, the access pattern of the memory could indicate a sequence of memory locations that are accessed (read or written) during a given period. In an embodiment, the information collection module 114 is a computer program that is executed by a processor of the host device 100. In another embodiment, the information collection module 114 is implemented by a controller including one or more hardware counters, logic circuits, and registers. For example, a logic circuit can control a hardware counter to count the number of instructions executed by the processor during a given period to generate a workload value. For example, a logic circuit can set registers to indicate the sequence of applications or memory locations accessed during a given period to generate an access pattern.

The model classifier 160 selects a model in which the host device 100 accesses the storage device 200, based on the host environment information HEI. For example, the model classifier 160 may select one of predefined models based on the host environment information HEI. In an embodiment, the model classifier 160 includes a classifier created as a result of machine learning and selects a model by using the classifier. The model classifier 160 sends a model selection request MSR indicating the selected model to the storage device 200.

The storage device 200 includes a model selection module 234, a model execution processor 240 (e.g., a central processing unit, a digital signal processor, etc.), and a nonvolatile memory device 280. The model selection module 234 selects a model depending on the model selection request MSR. In an embodiment, the host device 100 sends a signal to the storage device 200 including the model selection request MSR. The model selection module 234 may load model data MOD of the selected model on the model execution processor 240. In an embodiment, the model selection module 234 is implemented as a computer program that is executed by a processor of the storage device 234. In an embodiment, the model selection module 234 is implemented by a logic circuit, a memory or registers storing the model data MOD of each of a plurality of models, and a multiplexer input with signals indicative of the models, where the model selection request MSR is applied as a control signal to the multiplexer to cause output of one of the signals to the logic circuit, and the logic circuit loads the corresponding model data MOD onto the model execution processor 240.

The model execution processor 240 receives the model data MOD from the model selection module 234. The model execution processor 240 executes the selected model by executing the model data MOD. For example, the model execution processor 240 may schedule tasks corresponding to an access request from the host device 100, and background tasks or foreground tasks for managing the storage device 200, based on the selected model. A background task is a computer process that runs behind the in the background without user intervention (e.g., logging, system monitoring, scheduling, user notification, etc.).

For example, the model data MOD may include a classifier created as a result of machine learning. The model execution processor 240 may schedule various tasks based on the machine learning and priorities or weights assigned by the selected model. In an embodiment, the classifier is an executable program that is configured to classify data into one of a plurality of different classes.

The nonvolatile memory device 280 may be accessed according to the tasks scheduled by the model execution processor 240. The nonvolatile memory device 280 may include at least one of various nonvolatile memory devices such as a flash memory device, a phase change random access memory (PRAM) device, a ferroelectric random access memory (FRAM) device, or a resistive random access memory (RRAM) device.

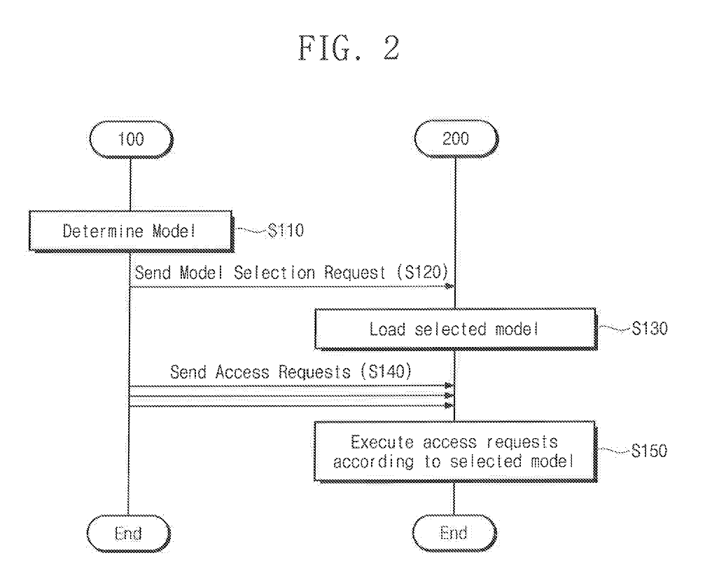

FIG. 2 is a flowchart illustrating an operating method of the computing system 10 according to an exemplary embodiment of the inventive concept. Referring to FIGS. 1 and 2, in operation S110, the model classifier 160 of the host device 100 performs machine learning-based classification on the host environment information HEI and selects a model based on the classification result. For example, the model classifier 160 may select an access model associated with the storage device 200.

In operation S120, the model classifier 160 of the host device 100 sends the model selection request MSR indicating the selected model to the storage device 200. In operation S130, the model selection module 234 of the storage device 200 loads model data MOD of the selected model on the model execution processor 240.

If the model is completely selected (changed), in operation S140, the host device 100 sends access requests to the storage device 200. For example, the access requests may include a write request, a read request, or a trim request. The trim request may allow the host device 100 to inform the storage device 200 of information of a deleted file. In an embodiment, the trim request informs the storage device 200 of which blocks of the storage device 200 are no longer considered in use so they can be deleted internally.

In operation S150, the model execution processor 240 of the storage device 200 executes the access requests depending on the selected model. For example, the model data MOD may include a task classifier that is based on machine learning. The model execution processor 240 may perform task classification based on the access requests from the host device 100 or pieces of environment information of the storage device 200. The model execution processor 240 may schedule an access task (e.g., a task that writes data to memory or reads data from memory), a background task, or a foreground task associated with the nonvolatile memory device 280 based on the classification result.

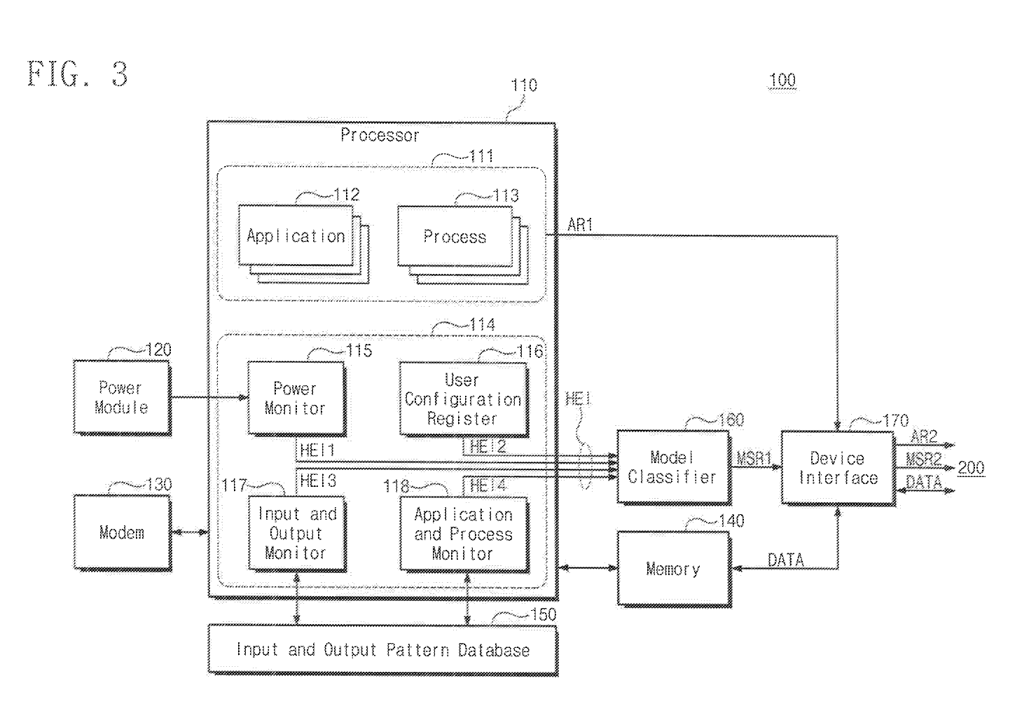

FIG. 3 is a block diagram illustrating the host device 100 according to an exemplary embodiment of the inventive concept. Referring to FIGS. 1 and 3, the host device 100 includes a processor 110, a power module 120, a modem 130, a memory 140, an input and output pattern database 150, the model classifier 160, and a device interface 170.

The processor 110 includes an application module 111 and the information collection module 114. The application module 111 may execute various applications 112 and processes 113 that use the storage device 200. The application module 111 may be automatically driven according to a request of a user or an internal schedule of the processor 110 and need not be associated with selection of a model.

The applications 112 or the processes 113 generate a first access request AR1 for accessing the storage device 200. For example, the first access request AR1 may include a read, write, or trim request for the storage device 200. The first access request AR1 may be transmitted to the device interface 170.

The information collection module 114 performs tasks associated with selection of a model. The information collection module 114 includes a power monitor 115, a user configuration register 116, an input and output monitor 117, and an application and process monitor 118. The power monitor 115, the user configuration register 116, the input and output monitor 117, and the application and process monitor 118 respectively collect first host environment information HEI1, second host environment information HEI2, third host environment information HEI3, and fourth host environment information HEI4 and provide the model classifier 160 with the first to fourth host environment information HET1 to HEI4 as the host environment information HEI.

The power monitor 115 collects information associated with power of the host device 100 from the power module 120, as the first host environment information HEI1. The following table 1 shows an example of the first host environment information HET1 of the host device 100, which the power monitor 115 collects. For example, the power monitor 115 could retrieve one or more rows of the table 1 from the power module 120. The Power type in table 1 indicates whether the host device 100 is powered by AC or DC power. The Battery level in table 1 indicates a charge percentage of a battery providing power to the host device 100. The Count in the table 1 indicates the number of times that the host device 100 enters the lower-power mode during a previous time period. For example, if the Count is 2, the host device 100 has entered the low-power mode two times during the previous N seconds. The Duration in the table 1 indicates an amount of time the host device 100 maintained the low-power mode, during a previous period. For example, if the Duration is 3 and the units of the Duration are seconds, the host device 100 maintained the low-power mode for 3 seconds.

TABLE 1

| Identifier | Name | Value | Description |
|---|---|---|---|
| 0 | Power type | 1 | 0: AC |
| | | | 1: DC (battery power) |
| 1 | Battery level | 50 | 0: Fully discharged |
| | | | 100: Fully charged |
| 2 | Count of power | 2 | Count to enter low-power |
| | mode change | | mode during previous N |
| | | | seconds (N being a |
| | | | positive integer) |
| 3 | Duration of | 3 | Total time (second) of |
| | low-power | | low-power mode maintained |
| | mode | | during previous N seconds |

The user configuration register 116 stores information configured by the user. The user configuration register 116 may store preset operation preferences. The user configuration register 116 may further store information about an operation tendency preferred by the user among stored operation tendencies. The user configuration register 116 may provide information about operation tendencies as the second host environment information HEI2. The following table 2 shows an example of the second host environment information HEI2 collected by the user configuration register 116. For example, the Environment type in table 2 may indicate the type of a device that the storage device belongs (e.g., the host device 100). The Performance-centered parameter in table 2 may be a measure of how interested the user is in performance (e.g., operating at a high operating frequency). The Low power-centered parameter of table 1 may indicate how interested the user is in saving power. The Reliability-centered parameter in table 2 may indicate how interested the user is in reliable data. For example, if the value of the parameter is high, the host device 100 could store redundant copies of data and/or store data with error correcting codes on the storage device 200.

TABLE 2

| Identifier | Name | Value | Description |
|---|---|---|---|
| 0 | Environment type | 1 | 0: Laptop computer |
| | | | 1: Desktop computer |
| | | | 2: Server |
| | | | 3: Portable computer |
| | | | 4: Others |
| 1 | Performance- | 70 | 0: Ignore |
| | centered | | 100: Strong preference |
| 2 | Low power- | 10 | Sum of 1 to 3 is 100 |
| | centered | | |
| 3 | Reliability-centered | 20 | |

The input and output monitor 117 monitors a characteristic in which the host device 100 accesses the storage device 200 and provides the monitoring result as the third host environment information HEI3. For example, the input and output monitor 117 may monitor a characteristic in which the host device 100 accesses the storage device 200 during a previous “N” seconds (N being a positive integer). The following table 3 shows an example of information that the input and output monitor 117 collects as the third host environment information HEI3. The Idle time parameter of table 3 may indicate the last amount of time the host device 100 was idle (e.g., did not access the storage device 200). The Read load parameter of table 3 may indicate a percentage of the read bandwidth used by the host device 100 during a previous period. The Write load parameter of table 3 may indicate a percentage of the write bandwidth used by the host device 100 during a previous period. The Expected read load parameter of table 3 may indicate a percentage of the read bandwidth that the host device 100 is expected to use during a next period. The Expected write load parameter of table 3 may indicate a percentage of the write bandwidth that the host device 100 is expected to use during a next period. The Number of opened file handlers parameter of table 3 may indicate the number of file handlers or file descriptors opened to open files stored on the storage device 200.

TABLE 3

| Identifier | Name | Value | Description |
|---|---|---|---|
| 0 | Idle time | 7 | Average idle time (seconds) during previous N |
| | | | seconds |
| 1 | Read load | 35 | Read load during previous N seconds |
| | | | 0: Idle |
| | | | 100: Maximum read bandwidth of storage device |
| | | | 200 |
| 2 | Write load | 20 | Write load during previous N seconds |
| | | | 0: Idle |
| | | | 100: Maximum write bandwidth of storage device |
| | | | 200 |
| 3 | Expected read load | 10 | Read load expected during next N seconds |
| | | | 0: Idle |
| | | | 100: Maximum read bandwidth of storage device |
| | | | 200 |
| 4 | Expected write load | 20 | Write load expected during next N seconds |
| | | | 0: Idle |
| | | | 100: Maximum write bandwidth of storage device |
| | | | 200 |
| 5 | Number of opened file | 42 | Number of opened file handlers |
| | handlers | | |

The application and process monitor 118 may collect information about access patterns of the applications 112 or the processes 113 executed in the processor 110 from the input and output pattern database 150. The application and process monitor 118 may provide the collected information as the fourth host environment information HEI4. The following table 4 shows an example of the fourth host environment information HEI4 collected by the application and process monitor 118.

TABLE 4

| | | | Aver- | Aver- | Sequen- | Sequen- |
|---|---|---|---|---|---|---|
| | | | age | age | tial | tial |
| Iden- | Application | | read | write | read | write |
| tifier | name | Process name | load | load | ratio | ratio |
| 1 | Word | WORD.exe | 10 | 30 | 70 | 10 |
| | processor | | | | | |
| 2 | Media player | PLAYER.exe | 70 | 10 | 90 | 80 |
| 3 | File sharing | TORRENT.exe | 50 | 80 | 90 | 90 |
| 4 | Explorer | EXPLORER.exe | 30 | 40 | 30 | 10 |

For example, an application having a name of “word processor” may execute a process having a name of “WORD.exe”. As an example, an average read load of the word processor may have a value of “10” between “0” and “100”. The average read load may indicate how read intensive the application is during a given period. An average write load of the word processor may have a value of “30” between “0” and “100”. The average write load may indicate how write intensive the application is during a given period. A sequential read ratio of the word processor may have a value of “70” between “0” and “100”. A sequential write ratio of the word processor may have a value of “10” between “0” and “100”.

For example, an application having a name of “media player” may execute a process having a name of “PLAYER.exe”. An average read load of the media player may be “70”, an average write load thereof may be “10”, a sequential read ratio thereof may be “90”, and a sequential write ratio thereof may be “80”. An application having a name of “file sharing” may execute a process having a name of “TORRENT.exe”. An average read load of the file sharing may be “50”, an average write load thereof may be “80”, a sequential read ratio thereof may be “90”, and a sequential write ratio thereof may be “90”.

An application having a name of “explorer” may execute a process having a name of “EXPLORER”. An average read load of the explorer may be “20”, an average write load thereof may be “10”, a sequential read ratio thereof may be “40”, and a sequential write ratio thereof may be “10”.

In the case where pattern information of a specific application/process among the applications 112 or the processes 113 is not stored in the input and output pattern database 150, the processor 110 may request the pattern information of the specific application/process from a server through the modem 130. In the case where pattern information is absent from a server, the input and output monitor 117 may analyze a pattern in which the specific application/process accesses the storage device 200.

The input and output monitor 117 may store the analysis result in the input and output pattern database 150 as pattern information of the specific application/process. For example, the processor 110 may upload the pattern information of the specific application/process to a server through the modem 130.

The power module 120 may supply power to the host device 100. The power module 120 may include a battery or a rectifier as an example. The modem 130 may communicate with an external device through wired or wireless communication under control of the processor 110. The memory 140 may be a working memory or a system memory of the processor 110. The memory 140 may include a dynamic random access memory (DRAM).

The input and output pattern database 150 may include information about patterns of an input and output through which applications or processes access the storage device 200. The input and output pattern database 150 may be stored in a nonvolatile memory. For example, the input and output pattern database 150 may be stored in the nonvolatile memory device 280 of the storage device 200.

For example, the processor 110 may send an access request to the storage device 200 through the device interface 170, thus access (or search for) the input and output pattern database 150 stored in the nonvolatile memory device 280 of the storage device 200.

As another example, the input and output pattern database 150 may be stored in a remote server. In this example, the input and output pattern database 150 is not locally stored in the computing system 10. The processor 110 may send an access request to the remote server through the modem 130, thus accessing the input and output pattern database 150 stored in the remote server.

The input and output pattern database 150 may store information about patterns in which applications or processes installed or not installed in the host device 100 or processes previously executed or not executed in the host device 100 that access the storage device 200. For example, the input and output pattern database 150 could indicate a sequence of applications or processes that has accessed the storage device 200 during a given period or a series of data that has accessed in the storage device 200.

In an embodiment, the model classifier 160 is created using machine learning. In an embodiment, the model classifier 160 receives the host environment information HEI and classifies a model suitable for the storage device 200 based on the host environment information HEI. The model classifier 160 sends a first model selection request MSR1 including the information of the classified models to the device interface 170. The following table 5 shows an example of a classification result of the model classifier 160.

TABLE 5

| | | | Result |
|---|---|---|---|
| Identifier | Preference characteristic | Expected load | (probability) |
| 0 | Performance-centered | Write concentration | 10% |
| 1 | Performance-centered | Read concentration | 12% |
| 2 | Performance-centered | Balance | 57% |
| 3 | Performance-centered | Minimum or idle | 2% |
| 4 | Low power-centered | Write concentration | 2% |
| 5 | Low power-centered | Read concentration | 1% |
| 6 | Low power-centered | Balance | 2% |
| 7 | Low power-centered | Minimum or idle | 2% |
| 8 | Reliability-centered | Write concentration | 5% |
| 9 | Reliability-centered | Read concentration | 3% |
| 10 | Reliability-centered | Balance | 2% |
| 11 | Reliability-based | Minimum or idle | 2% |

As shown in table 5, the model classifier 160 may classify probability of performance centered and balance the highest. The model classifier 160 may send the first model selection request MSR1 to the device interface 170 so as to select a model corresponding to the performance centered and balance. For example, a balanced expected load may mean that the number of reads is expected to be equal to the number of writes or that the amount of resources used to perform the reads is expected to be the same as the amount of resources used to perform the writes.

As shown in table 5, the model classifier 160 may perform classification by using a tendency of a user stored in the user configuration register 116 as a first element (or a main element). The model classifier 160 may perform classification by using the remaining environment information other than the tendency of the user as a second element (or an additional element).

For example, the model classifier 160 may be implemented with a separate semiconductor chip that is separated from the processor 110. For example, the model classifier 160 may be implemented with a semiconductor chip, which is suitable to perform machine learning-based classification, such as a field programmable gate array (FPGA), a graphics processor (GPU), or a neuromorphic chip.

The device interface 170 receives the first access request AR1 from the processor 110 and receives the first model selection request MSR1 from the model classifier 160. The device interface 170 may receive a signal from the model classifier 160 including the first model selection request AR1. The device interface 170 may translate the first access request AR1 and the first model selection request MSR1 having a format used within the host device 100 to a second access request AR2 and a second model selection request MSR2 having a format used in communication between the host device 100 and the storage device 200, respectively.

The device interface 170 sends the second access request AR2 and the second model selection request MSR2 to the storage device 200. When the second access request AR2 is a read request, the device interface 170 reads data corresponding to the read request from the memory 140 and sends the read data to the storage device 200. When the second access request AR2 is a write request, the device interface 170 stores data transmitted from the storage device 200 in the memory 140.

As described above, the host device 100 may perform machine learning-based model classification based on the tendency of the user and the environment of the host device 100. The host device 100 may send (e.g., direct, propose, or recommend) a model, which is classified as being suitable for the storage device 200, to the storage device 200 through the second model selection request MSR2.

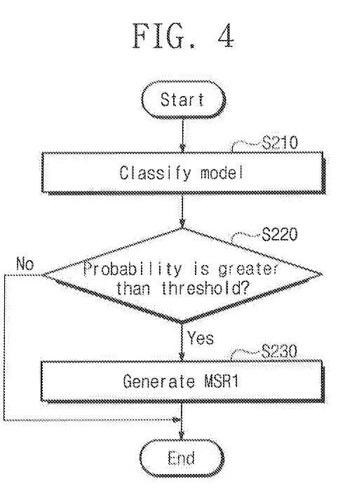

FIG. 4 is a flowchart illustrating an example in which the model classifier 160 generates the first model selection request MSR1. Referring to FIGS. 3 and 4, in operation S210, the model classifier 160 classifies a model. For example, the model classifier 160 may perform classification depending on a predefined time period. As another example, the model classifier 160 may perform classification depending on a request of the user or an external device.

In operation S220, the model classifier 160 determines whether a probability of a selected model (e.g., a model having the highest probability) is greater than a threshold. For example, the threshold may be set by the model classifier 160. As another example, the threshold may be set by the user or the external device. The threshold may be stored in the user configuration register 116.

If the probability of the selected model is greater than the threshold, the model classifier 160 generates the first model selection request MSR1. That is, on the basis of the selected model, the model classifier 160 maintains a previous model or requests selection of a new model through the first model selection request MSR1. For example, in the case where a previous model is maintained, the model classifier 160 may skip generation of the first model selection request MSR1.

In an embodiment, if the probability of the selected model is not greater than the threshold, the model classifier 160 does not generate the first model selection request MSR1. That is, a model that was previously selected and executed in the storage device 200 is maintained. According to the embodiment described with reference to FIG. 4, a model of the storage device 200 may be suppressed from being frequently changed, and accordingly an overhead due to the model change may be reduced.

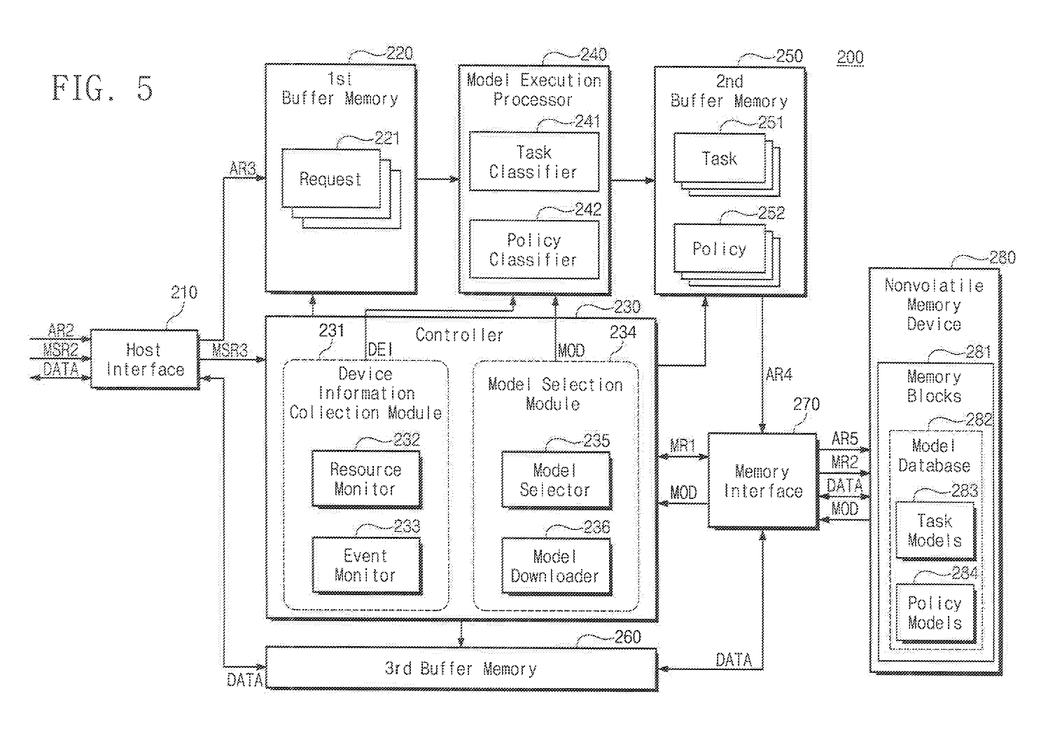

FIG. 5 is a block diagram illustrating the storage device 200 according to an exemplary embodiment of the inventive concept. For example, the storage device 200 may correspond to various storage devices such as a solid state drive (SSD), a memory card, or an embedded memory.

Referring to FIGS. 1, 3, and 5, the storage device 200 includes a host interface 210, a first buffer memory 220, a controller 230, the model execution processor 240, a second buffer memory 250, a third buffer memory 260, a memory interface 270, and the nonvolatile memory device 280.

The host interface 210 may receive the second access request AR2 and the second model selection request MSR2 from the device interface 170. The host interface 210 may translate the second access request AR2 and the second model selection request MSR2 having a format used in communication between the host device 100 and the storage device 200 to a third access request AR3 and a third model selection request MSR3 having a format used within the storage device 200, respectively.

The host interface 210 sends the third access request AR3 to the first buffer memory 220. The host interface 210 may send a signal including the third access request AR3 to the first buffer memory 220. The host interface 210 sends the third model selection request MSR3 to the controller 230. The host interface 210 may send a signal including the third model selection request MSR3 to the controller 230. When the third access request AR3 is a write request, the host interface 210 stores data received from the device interface 170 in the third buffer memory 260. After data is stored in the third buffer memory 260 depending on the write request, the host interface 210 sends the data stored in the third buffer memory 260 to the memory interface 270.

The first buffer memory 220 receives the third access request AR3 from the host interface 210. For example, the first buffer memory 220 may be a queue to store third access requests. The first buffer memory 220 may be provided within the controller 230, may be provided within the model execution processor 240, or may be combined with the second buffer memory 250 or the third buffer memory 260.

The controller 230 may execute firmware for driving the storage device 200. The controller 230 may control components of the storage device 200 depending on the firmware. The controller 230 may receive the third model selection request MSR3 from the host interface 210. The controller 230 may select a model based on the third model selection request MSR3 and may load the selected model on the model execution processor 240.

The controller 230 includes a device information collection module 231 and the model selection module 234. The device information collection module 231 collects environment information of the storage device 200 and provides the collected environment information to the model execution processor 240 as device environment information DEI. The controller 230 may output a signal including the device environment information DEI to the model execution processor 240.

The device information collection module 231 may include a resource monitor 232 and an event monitor 233. The resource monitor 232 may monitor resources of the storage device 200 and may include information about the resources in the device environment information DEI. The following table 6 shows an example of the device environment information DEI that the resource monitor 232 provides. The single level cell free memory block parameter of table 6 may indicate a percentage of the memory blocks of the storage 200 that are free and whose memory cell is configured to store only a single bit. The multi-level cell free memory block parameter of table 6 may indicate a percentage of the memory blocks of the storage 200 that are free and whose memory cell is configured to store two bits. The triple level cell free memory block parameter of table 6 may indicate a percentage of the memory blocks of the storage 200 that are free and whose memory cell is configured to three or more bits. The valid data ratio parameters of table 6 may indicate a percentage of the memory cells of a certain type that have valid data. The max/mix program/erase count parameters of the table 6 may indicate a maximum/minimum number of program/erase operations performed in the memory cells of a certain type. The Residual ratio of buffer memory parameter may indicate how full or empty the buffer memories are.

TABLE 6

| Identifier | Name | Value | Description |
|---|---|---|---|
| 0 | single level cell free memory block | 50 | 0: No free memory block or |
| 1 | multi-level cell free memory block | 0 | unavailable type |
| 2 | triple level cell free memory block | 30 | 100: All memory blocks are free |
| | | | memory blocks |
| 3 | Valid data ratio of single level cells | 20 | 0: No valid data |
| 4 | Valid data ratio of multi-level cells | 0 | 100: All data are valid data |
| 5 | Valid data ratio of triple level cells | 50 | |
| 6 | Max program/erase count of single | 30 | 0: Memory blocks does not |
| | level cells | | deteriorate |
| 7 | Max program/erase count of multi- | 0 | 100: Memory blocks reaches a |
| | level cells | | secured max program/erase |
| 8 | Max program/erase count of triple | 10 | count |
| | level cells | | |
| 9 | Min program/erase count of single | 25 | |
| | level cells | | |
| 10 | Min program/erase count of multi- | 0 | |
| | level cells | | |
| 11 | Min program/erase count of triple | 8 | |
| | level cells | | |
| 12 | Residual ratio of buffer memory | 7 | Second or third buffer memories |
| | | | (220, 250, 260) |
| | | | 0: Full |
| | | | 100: Empty |

A memory cell storing 1-bit data may be a single level cell. A memory block including single level cells may be a single level cell memory block. A memory block including single level cells where data are not stored may be a free memory block of single level cells.

A memory cell storing 2-bit data may be a multi-level cell. A memory cell storing 3-bit data may be a triple level cell. However, the inventive concept is not limited to single level cells, multi-level cells, and triple level cells. For example, the inventive concept may also be applied to a case where four or more data bits are stored in one memory cell.

The event monitor 233 may monitor events occurring in the storage device 200 and may include information about the events in the device environment information DEI. The following table 7 shows an example of the device environment information DEI that the event monitor 233 collects.

TABLE 7

| Identifier | Name | Value | Description |
|---|---|---|---|
| 0 | Pending read requests | 20 | Amount of read requests of host device 100 |
| | | | pending |
| | | | 0: No load |
| | | | 100: Great load |
| 1 | Pending write requests | 50 | Amount of write requests of host device 100 |
| | | | pending |
| | | | 0: No load |
| | | | 100: Great load |
| 2 | Pending trim requests | 5 | Amount of trim requests of host device 100 |
| | | | pending |
| | | | 0: No load |
| | | | 100: Great load |
| 3 | Program error occurs | 0 | 0: No event |
| | | | 1: Program error occurs |
| 4 | Read error occurs | 0 | 0: No event |
| | | | 1: Uncorrectable read error occurs |
| 5 | Read refresh is necessary | 0 | 0: No event |
| | | | 1: Correctable read error occurs and error is |
| | | | detected in data scrubbing or read refresh is |
| | | | necessary depending on internal algorithm |
| 6 | Wear-leveling is | 1 | 0: No event |
| | necessary | | 1: Wear-leveling is necessary (wear level exceeds |
| | | | threshold) |
| 7 | Garbage collection is | 0 | 0: No event |
| | necessary | | 1: Garbage collection is necessary |
| 8 | Idle time | 0 | 0: Time (ms) elapsing after last request of host |
| | | | device 100 has completed |

Read requests, write requests, or trim requests of the host device 100 pending may include requests stored in the first buffer memory 220 or tasks issued by the host device 100 and scheduled in the second buffer memory 250 through classification of the model execution processor 240.

The model selection module 234 may select a model depending on the third model selection request MSR3. The model selection module 234 includes a model selector 235 and a model downloader 236. The model selector 235 sends a first model request MR1 requesting a model selected by the third model selection request MSR3 to the memory interface 270. The model selector 235 may send a signal to the memory interface 270 including the first model request MR1.

If model data MOD of the selected model is stored in the nonvolatile memory device 280, the memory interface 270 may read the model data MOD from the nonvolatile memory device 280. If the model data MOD is transmitted from the memory interface 270, the model selector 235 may send (or load) the model data MOD to the model execution processor 240.

In the case where the model data MOD of the selected model is not transmitted from the memory interface 270, for example, in the case where the model data MOD of the selected model is not stored in the nonvolatile memory device 280, the model downloader 236 may request the model data MOD from the host device 100. The model data MOD may be stored in the nonvolatile memory device 280 through the third buffer memory 260 as a part of data.

The model execution processor 240 may receive and execute the model data MOD of the selected model from the controller 230. In an embodiment, the selected model includes a task classifier 241 and a policy classifier 242. In an embodiment, the task classifier 241 performs machine learning-based classification on the device environment information DEI. The following table 8 shows an example of tasks classified by the task classifier 241.

TABLE 8

| | | Result | |
|---|---|---|---|
| Identifier | Name | (probability) | Description |
| 0 | Idle | 0 | Do not schedule tasks |
| 1 | Read | 27 | Schedule read request of host device 100 |
| | | | as task |
| 2 | Write | 53 | Schedule write request of host device 100 |
| | | | as task |
| 3 | Trim | 10 | Schedule trim request of host device 100 as |
| | | | task |
| 4 | Garbage collection | 0 | Schedule garbage collection to secure free |
| | | | memory blocks through integration of |
| | | | valid data as task |
| 5 | Data scrubbing | 10 | Schedule data scrubbing to check error |
| | | | sensitivity through scanning of data of |
| | | | memory blocks as task |
| 6 | Wear-leveling | 0 | Schedule wear-leveling management to |
| | management | | swap memory blocks having a high |
| | | | program/erase count and memory blocks of |
| | | | a low program/erase count as task |
| 7 | Read refresh | 0 | Schedule read refresh to move valid data of |
| | | | target memory block to free memory block |
| | | | as task |
| 8 | Exception processing | 0 | Schedule exception processing to process |
| | | | exception events such as program error and |
| | | | read error as task |
| 9 | Data transfer | 0 | Schedule data transfer to transfer data |
| | | | stored in single level cells, multi-level |
| | | | cells, or triple level cells to other level cells |
| | | | as task |

For example, the task classifier 241 may select a task, the probability of which is greater than a threshold, or two or more tasks as described with reference to FIG. 4. For example, in the case where the threshold is “30”, the task classifier 241 selects a write operation as a task. In the case where the threshold is “25”, the task classifier 241 selects a write operation and a read operation as a task.

The policy classifier 242 may classify a policy corresponding to a selected task depending on the device environment information DEI and the selected task (e.g., a scheduled task). The following table 9 shows an example of policies classified by the policy classifier 242.

TABLE 9

| | | Result |
|---|---|---|
| Identifier | Policy | (probability) |
| 0 | Allocate single level cell memory block | 71 |
| 1 | Allocate multi-level cell memory block | 0 |
| 2 | Allocate triple level cell memory block | 19 |
| 3 | Data transfer from single level cell memory block to multi-level | 1 |
| | cell memory block | |
| 4 | Data transfer from single level cell memory block to triple level | 0 |
| | cell memory block | |
| 5 | Data transfer from multi-level cell memory block to triple level | 0 |
| | cell memory block | |
| 6 | Wear-leveling management of single level cell memory block | 1 |
| 7 | Wear-leveling management of multi-level cell memory block | 0 |
| 8 | Wear-leveling management of triple level cell memory block | 2 |
| 9 | Garbage collection of single level cell memory block | 1 |
| 10 | Garbage collection of multi-level cell memory block | 0 |
| 11 | Garbage collection of triple level cell memory block | 5 |
| 12 | Data scrubbing of single level cell memory block | 1 |
| 13 | Data scrubbing of multi-level cell memory block | 0 |
| 14 | Data scrubbing of triple level cell memory block | 0 |

When a selected task is associated with a write operation, one of policies “0” to “2” may be selected. When a selected task is associated with a data transfer, one of policies “3” to “5” may be selected. When a selected task is associated with wear-leveling management, one of policies “6” to “8” may be selected. When a selected task is associated with garbage collection, one of policies “9” to “11” may be selected.

When a selected task is associated with data scrubbing, one of policies “12” to “14” may be selected. In an embodiment, the data scrubbing uses a background task to periodically inspect the storage device 200 for errors, then corrects detected errors using redundant data. That is, with regard to the selected task, a single level cell memory block, a multi-level cell memory block, or a triple level cell memory block may be selected as a task target. For example, when two or more tasks are selected, two or more policies corresponding to the selected tasks may be selected.

The model execution processor 240 may fetch a request corresponding to a selected task among requests stored in the first buffer memory 220. For example, the model execution processor 240 may fetch a request corresponding to a selected task from the first buffer memory 220 in a first-in first-out manner or depending on a priority assigned to requests 221.

The model execution processor 240 may schedule the fetched request as a task in the second buffer memory 250. The model execution processor 240 may schedule the selected policy in the second buffer memory 250. For example, tasks 251 may have corresponding policies 252, respectively. As another example, some of tasks may have corresponding policies while the remaining tasks do not have corresponding policies.

The model execution processor 240 may be implemented with a separate semiconductor chip that is separated from the controller 230. For example, the model execution processor 240 may be implemented with a semiconductor chip, which is suitable to perform machine learning-based classification, such as a field programmable gate array (FPGA), a graphics processor (GPU), or a neuromorphic chip.

The second buffer memory 250 may store the tasks 251 and the policies 252 scheduled by the model execution processor 240. For example, the second buffer memory 250 may be a queue to store the tasks 251 and the policies 252. The second buffer memory 250 may be provided within the controller 230, may be provided within the model execution processor 240, or may be combined with the first buffer memory 220 or the third buffer memory 260.

The third buffer memory 260 may be a system memory or a main memory used to drive firmware of the controller 230. The third buffer memory 260 may be used to buffer data conveyed between the host device 100 and the nonvolatile memory device 280. The third buffer memory 260 may be included within the controller 230 or the model execution processor 240. The third buffer memory 260 may be combined with the first buffer memory 220 or the second buffer memory 250.

The memory interface 270 receives the first model request MR1 from the controller 230. The memory interface 270 may translate the first model request MR1 to the second model request MR2 having a format used in communication between the memory interface 270 and the nonvolatile memory device 280. The memory interface 270 sends the second model request MR2 to the nonvolatile memory device 280. The memory interface 270 may send a signal including the second model request MR2 to the nonvolatile memory device 280.

The nonvolatile memory device 280 may output the model data MOD in response to the second model request MR2. The memory interface 270 may send the model data MOD to the controller 230. As another example, the memory interface 270 may store the model data MOD in the third buffer memory 260. The model data MOD stored in the third buffer memory 260 may be transmitted (or loaded) to the model execution processor 240.

The memory interface 270 may fetch a task and a policy as a fourth access request AR4 from the second buffer memory 250. For example, the memory interface 270 may fetch a task and a policy in a first-in first-out manner or based on an assigned weight.

The memory interface 270 may translate the fetched fourth access request AR4 to a fifth access request AR5 having a format used in communication between the memory interface 270 and the nonvolatile memory device 280. The memory interface 270 sends the fifth access request AR5 to the nonvolatile memory device 280.

When the fifth access request ARS is a write request, the memory interface 270 sends data stored in the third buffer memory 260 to the nonvolatile memory device 280. When the fifth access request ARS is a read request, the memory interface 270 stores data transmitted from the nonvolatile memory device 280 in the third buffer memory 260.

The nonvolatile memory device 280 includes memory blocks 281. Each of the memory blocks 281 includes memory cells. The memory cells may include single level cells, multi-level cells, and/or triple level cells. A model database 282 may be stored in a first part of the memory blocks 281. The model database 282 may include task models 283 and policy models 284. User data may be stored in another part of the memory blocks 281. For example, first memory blocks may be used to store the model database 282 and second other memory blocks may be used to store user data.

The nonvolatile memory device 280 may perform a write, read, or erase operation on memory blocks in response to the fifth access request ARS. The nonvolatile memory device 280 may exchange data with the memory interface 270 in a write or read operation. In response to the second model request MR2, the nonvolatile memory device 280 may provide the memory interface 270 with one of task models 283 or one of policy models 284 stored in the model database 282 as the model data MOD.

As described above, the storage device 200 may select and execute a model in response to a request of the host device 100. The storage device 200 may schedule requests transmitted from the host device 100, background operations, or foreground operations depending on the selected model. Since scheduling of tasks is performed on the basis of the machine learning and since a machine learning model is changed according to a preference of the user and an environment, performance, power consumption, and reliability are optimized according to preferences of users. Thus, embodiments of the inventive concept are advantageous over conventional storage devices that schedule tasks based on a preset strategy resulting in sub-optimal performance, power consumption, and reliability. Further, when the storage device 200 of the inventive concept is disposed within a computer, it results in an improvement to the functioning of the computer as compared to computers that operate with a conventional storage device 200. For example, a computer including the storage device 200 and modified to include the elements of the host device 100 uses less power than a conventional computer, has a higher operating performance than a conventional computer, and is more reliable than a conventional computer.

In an embodiment, the model selection module 234 updates a model of the task classifier 241 and a model of the policy classifier 242 together in response to the third model selection request MSR3. As another example, the model selection module 234 may update one of a model of the task classifier 241 and a model of the policy classifier 242 in response to the third model selection request MSR3.

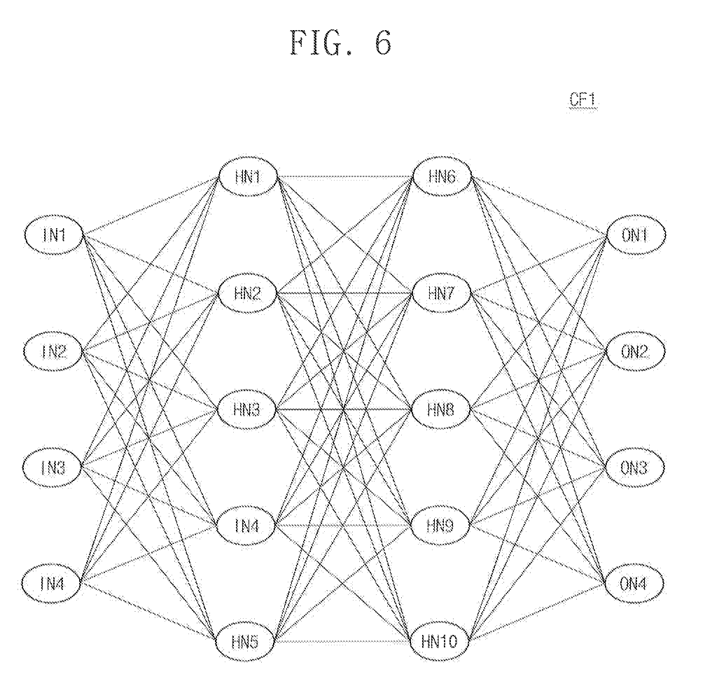

FIG. 6 shows an exemplary machine learning-based classifier CF1 which can be used in the model classifier 160, the task classifier 241, or the policy classifier 242. In an embodiment, the classifier CF1 is a neural network. Referring to FIG. 6, the classifier CF1 includes first to fourth input nodes IN1 to IN4, first to tenth hidden nodes HN1 to HN10, and first to fourth output nodes ON1 to ON4.

The number of input nodes, the number of hidden nodes, and the number of output nodes are not limited thereto. For example, the number of input nodes may be determined according to the amount or the number of information included in the host environment information HEI or the device environment information DEI input to the classifier CF1. The number of output nodes may be determined according to the number of models, the number of tasks, or the number of policies. The number of input nodes, the number of hidden nodes, and the number of output nodes may be determined in advance upon constructing the neural network.

The first to fourth input nodes IN1 to IN4 form an input layer. The first to fifth hidden nodes HN1 to HN5 form a first hidden layer. The sixth to tenth hidden nodes HN6 to HN10 form a second hidden layer. The first to fourth output nodes ON1 to ON4 form an output layer. The number of hidden layers or the number of hidden nodes of each hidden layer may be determined in advance upon constructing the neural network.

The host environment information HEI or the device environment information DEI may be input to the first to fourth input nodes IN1 to IN4. Environment information of different kinds may be input to different input nodes. The environment information of each input node is transmitted to the first to fifth hidden nodes HN1 to HN5 of the first hidden layer, with weights applied to the environment information thereof.

Information of each of the first to fifth hidden nodes HN1 to HN5 is transmitted to the sixth to tenth hidden nodes HN6 to HN10 of the second hidden layer, with weights applied to the information thereof. Information of each of the sixth to tenth hidden nodes HN6 to HN10 is transmitted to the first to fourth output nodes ON1 to ON4, with weights applied to the information thereof. Information of each of the first to fourth output nodes ON1 to ON4 may indicate a probability or a ratio as described with reference to table 5, table 8, or table 9.

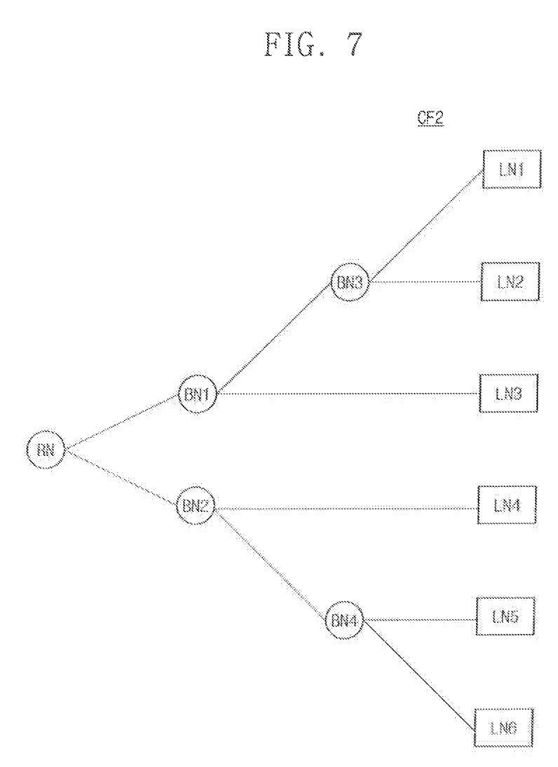

FIG. 7 shows a machine learning-based classifier CF2 according to another example, which can be used in the model classifier 160, the task classifier 241, or the policy classifier 242. In an embodiment, the classifier CF2 is a decision tree. Referring to FIG. 7, the classifier CF2 includes a root node RN, first to fourth internal nodes IN1 to IN4, and first to sixth leaf nodes LN1 to LN6. The root node RN, the first to fourth internal nodes IN1 to IN4, and the first to sixth leaf nodes LN1 to LN6 may be connected through branches.

In each of the root node RN and the first to fourth internal nodes IN1 to IN4, comparison may be made with respect to one of pieces of information included in the host environment information HEI or the device environment information DEI. Values may be respectively transmitted to a plurality of branches connected with each node according to the comparison result. The comparison and the transmission of values may be performed with respect to all internal nodes. Values transmitted to the first to sixth leaf nodes LN1 to LN6 may indicate a probability or a ratio as described with reference to table 5, table 8, or table 9.

As another example, one of a plurality of branches connected to each node may be selected according to the comparison result. In the case where another internal node has been connected to the selected branch, comparison may be made with respect to other information of the pieces of information included in the host environment information HEI or the device environment information DEI at the internal node. In the case where a leaf node has been connected to the selected branch, a value of the leaf value may be obtained as a classification result CR.

The number of the internal nodes IN1 to IN4, and the number of the leaf nodes LN1 to LN6 are not limited thereto. For example, the number of the internal nodes IN1 to IN4 may be determined according to the amount or the number of information included in the host environment information HEI or the device environment information DEI input to the classifier CF2. The number of leaf nodes may be determined according to the number of models, the number of tasks, or the number of policies.

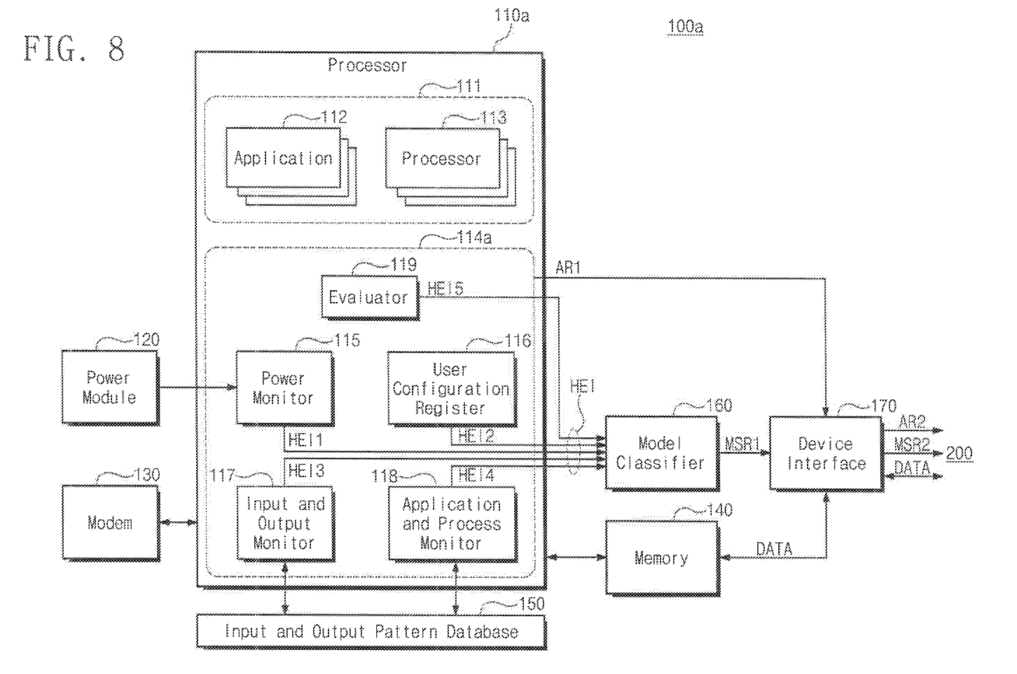

FIG. 8 is a block diagram illustrating a host device 100a according to an application of the inventive concept. Referring to FIGS. 1 and 8, the host device 100a includes a processor 110a, the power module 120, the modem 130, the memory 140, the input and output pattern database 150, the model classifier 160, and the device interface 170.

The processor 110a may include the application module 111 and an information collection module 114a. The application module 111 may execute various applications 112 and processes 113 that use the storage device 200. The information collection module 114a includes the power monitor 115, the user configuration register 116, the input and output monitor 117, the application and process monitor 118, and an evaluator 119.

Compared with the host device 100 of FIG. 3, the information collection module 114a of the processor 110a of the host device 100a further includes the evaluator 119. The evaluator 119 may evaluate the suitability of a selected model. For example, the evaluator 119 may evaluate access operations performed on the basis of the selected model. For example, the evaluator 119 may evaluate performance such as latencies of access operations. The evaluator 119 may send the evaluation result as the fifth host environment information HEI5 to the model classifier 160.

For example, the evaluator 119 may perform evaluation after the model is selected and a specific time elapses or after the model is selected and a specific number of access operations are performed and may provide the fifth host environment information HEI5. For example, the evaluator 119 may perform evaluation after the model is selected and at least one of a read operation, a write operation, and an erase operation or each of the read operation, the write operation, and the erase operation is performed as much as at least the specific number of times and may provide the fifth host environment information HEI5.

The model classifier 160 may further receive the fifth host environment information HEI5 as the host environment information HEI. The model classifier 160 may further perform classification on the basis of the fifth host environment information HEI5. On the basis of the fifth host environment information HEI5, the model classifier 160 may maintain a current model or may request replacement of the current model with a new model.

For example, the model classifier 160 may apply the fifth host environment information HEI5 after the model is selected and a specific time elapses or after the model is selected and a specific number of access operations are performed. For example, the model classifier 160 may apply the fifth host environment information HEI5 after the model is selected and at least one of a read operation, a write operation, and an erase operation or each of the read operation, the write operation, and the erase operation is performed as much as at least the specific number of times.

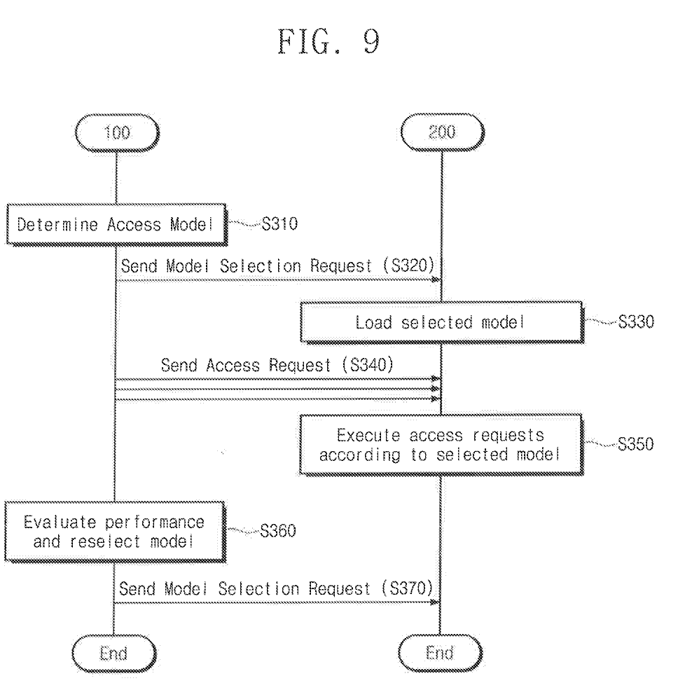

FIG. 9 is a flowchart illustrating an operating method of the computing system 10 according to an exemplary embodiment of the inventive concept. Referring to FIGS. 1 and 9, in operation S310, the model classifier 160 of the host device 100 may perform machine learning-based classification on the host environment information HEI and determines a model based on the classification result.

In operation S320, the model classifier 160 of the host device 100 sends the model selection request MSR indicating the selected model to the storage device 200. In operation S330, the model selection module 234 of the storage device 200 loads model data MOD of the selected model on the model execution processor 240.

If the model is completely selected (changed), in operation S340, the host device 100 may send access requests to the storage device 200. In operation S350, the model execution processor 240 of the storage device 200 executes the access requests depending on the selected model.

After access operations are performed in the storage device 200 depending on the access requests, operation S350 is performed. For example, operation S360 may be performed after the model is selected and a specific time elapses or after at least one of a read operation, a write operation, and an erase operation or each of the read operation, the write operation, and the erase operation is performed as much as at least the specific number of times.

In operation S360, the host device 100 evaluates performance and reselects a model. For example, the model classifier 160 may again perform selection (or classification) of a model based on the fifth host environment information HEI5 being the evaluation result of the evaluator 119. The model classifier 160 sends the model selection request MSR indicating the reselected model to the storage device 200 depending to the result of selection (or classification) thus again performed.

For example, if the reselected model is the same as a previous model, the model classifier 160 does not send the model selection request MSR to the storage device 200. If the reselected model is different from the previous model, the model classifier 160 sends the model selection request MSR to the storage device 200. The storage device 200 may replace a model depending on the model selection request MSR.

For example, the evaluation and the selection based on the evaluation may be consistently performed. For example, selection may be again performed on the basis of the fifth host environment information HEI5 of the evaluator 119 after the model is reselected and a specific time elapses or after the model is reselected and at least one of a read operation, a write operation, and an erase operation or each of the read operation, the write operation, and the erase operation is performed as much as at least the specific number of times.

For example, if the result of evaluating performance is lower than a threshold value, the model classifier 160 selects a model different from a previous model. If the result of evaluating performance is not smaller than the threshold value, the model classifier 160 maintains the previous model. The threshold value may vary depending on settings of the user configuration register 116. The threshold may be set by a user or an external device.

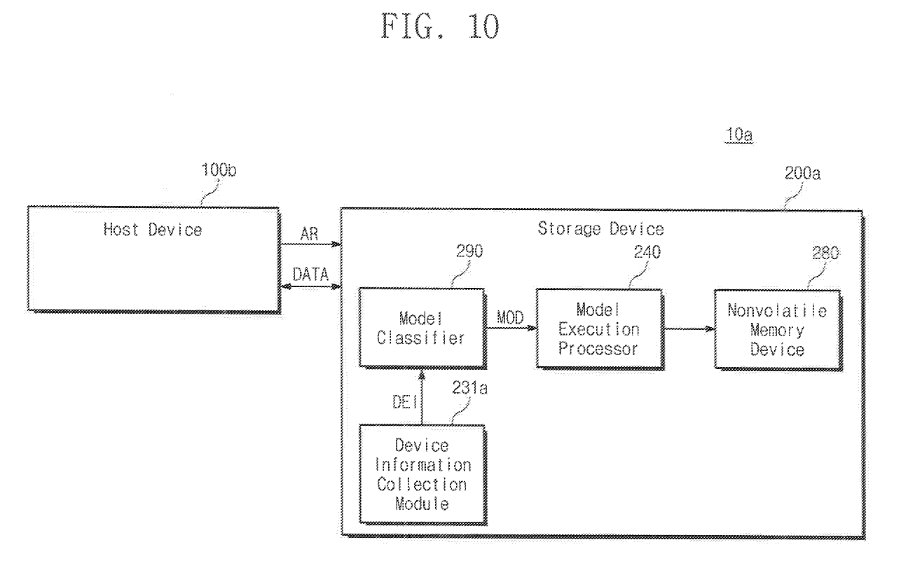

FIG. 10 is a block diagram illustrating a computing system 10a according to an exemplary embodiment of the inventive concept. Referring to FIG. 10, the computing system 10a includes a host device 100b and a storage device 200a. The host device 100b sends the access request AR to the storage device 200a to write data in the storage device 200a or read data from the storage device 200a.

Unlike the computing system 10 described with reference to FIG. 1, the host device 100b sends only the access request AR to the storage device 200a without sending the model selection request MSR. For example, the host device 100b does not include the information collection module 114 and the model classifier 160.

The storage device 200a may include the model execution processor 240, the nonvolatile memory device 280, the device information collection module 231a, and a model classifier 290. Compared with the storage device 200 of FIG. 1, the storage device 200a does not include the model selection module 234 and includes the device information collection module 231a and the model classifier 290.

The device information collection module 231a collects environment information of the storage device 200a and provides the collected environment information to the model execution processor 240 as the device environment information DEI. The model classifier 290 selects a model in which the storage device 200a processes the access request AR of the host device 100b, based on the device environment information DEI.

For example, the model classifier 290 may select one of models that are in advance determined by using a machine learning-based classifier with respect to the device environment information DEI. The model classifier 290 sends the model data MOD of the selected model to the model execution processor 240.

Compared with the computing system 10 of FIG. 1, the computing system 10a includes the storage device 200a configured to select a model without intervention of the host device 100b. Accordingly, even in the case where the host device 100b does not support selection of a model, the storage device 200a may automatically select and execute a model.

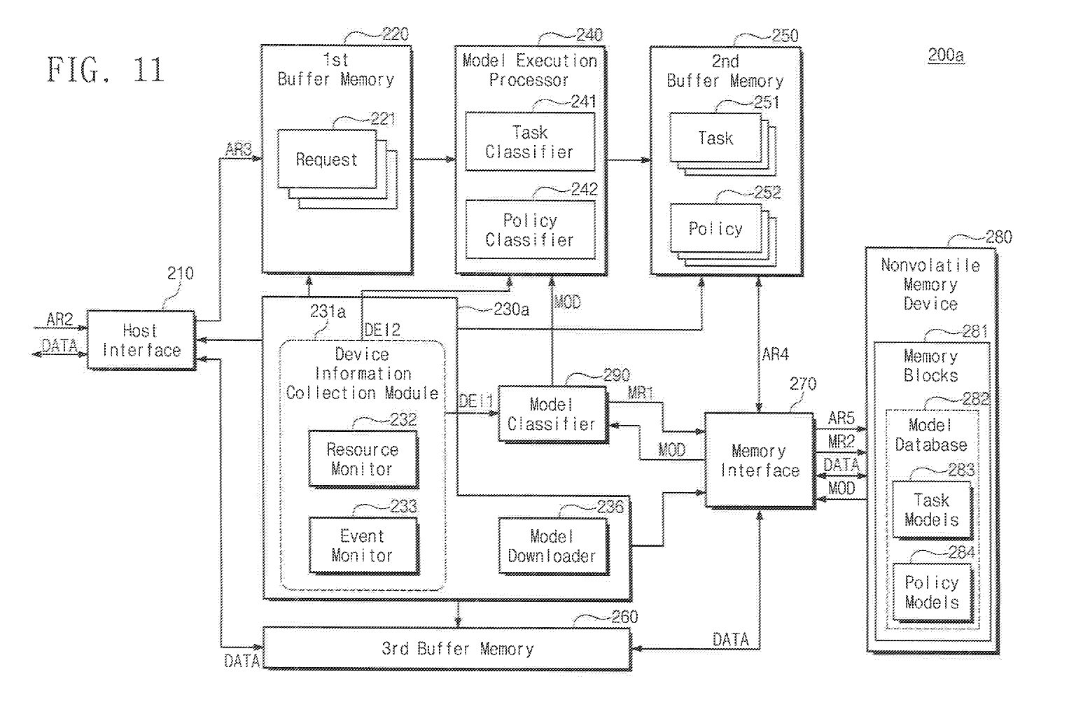

FIG. 11 is a block diagram illustrating the storage device 200a according to an application of the inventive concept. Referring to FIG. 11, the storage device 200a includes the host interface 210, the first buffer memory 220, a controller 230a, the model execution processor 240, the second buffer memory 250, the third buffer memory 260, the memory interface 270, the nonvolatile memory device 280, and the model classifier 290.

Compared with the storage device 200 of FIG. 5, the controller 230a has a configuration that differs from the configuration of the controller 230 of FIG. 5 and operates in a different manner than the controller 230. Compared to the storage device 200 of FIG. 5, the storage device 200 may further include the model classifier 290.

The controller 230a may include the device information collection module 231 and the model downloader 236. The device information collection module 231 may collect environment information of the storage device 200a and may provide a part or all of the collected environment information to the model classifier 290 as first device environment information DEI1 The device information collection module 231 may provide a part of all of the collected environment information to the model execution processor 240 as second device environment information DEI2.

For example, the first device environment information DEI1 and the second device environment information DEI2 may have overlapping information. For example, the first device environment information DEI1 and the second device environment information DEI2 do not coincide with each other. As another example, the first device environment information DEI1 and the second device environment information DEI2 coincide with each other.

When the model data MOD is not stored in the nonvolatile memory device 280, the model downloader 236 may request the model data MOD from the host device 100b. The model data MOD may be stored in the nonvolatile memory device 280 through the third buffer memory 260 as a part of data.

In an embodiment, the model classifier 290 is created using machine learning. The model classifier 290 may receive the device environment information DEI and may classify (or select) a model suitable for the storage device 200a based on the device environment information DEI. The model classifier 290 may send the first model request MR1 for requesting the classified models to the memory interface 270.

The model classifier 290 may send the model data MOD received from the memory interface 270 to the model execution processor 240 in response to the first model request MR1. The model classifier 290 may be implemented with a separate semiconductor chip that is separated from the controller 230a. For example, the model classifier 290 may be implemented with a semiconductor chip, which is suitable to perform machine learning-based classification, such as a field programmable gate array (FPGA), a graphics processor (GPU), or a neuromorphic chip.

The host interface 210, the first buffer memory 220, the model execution processor 240, the second buffer memory 250, the third buffer memory 260, the memory interface 270, and the nonvolatile memory device 280 may be configured and operate the same as those described with reference to FIG. 4, except that the host interface 210 and the controller 230a do not send the model selection request MSR2 or MSR3 and the model execution processor 240 performs task and policy classification (or selection) based on the second device environment information DEI2.

As described above, the storage device 200a includes the model classifier 290. The model classifier 290 may classify (or select) a model suitable for the storage device 200a based on the second device environment information DEI. The model execution processor 240 may execute the selected model to schedule the tasks 251 and the policies 252. Accordingly, the storage device 200a optimized to use a pattern of a user based on the machine learning is provided.

In an embodiment, as described with reference to FIG. 3, a device information collection module 231a may include the user configuration register 116. The device information collection module 231a may set the user configuration register 116 under control of the user or the external device. The device information collection module 231a may send information of the user configuration register 116 to the model classifier 290.

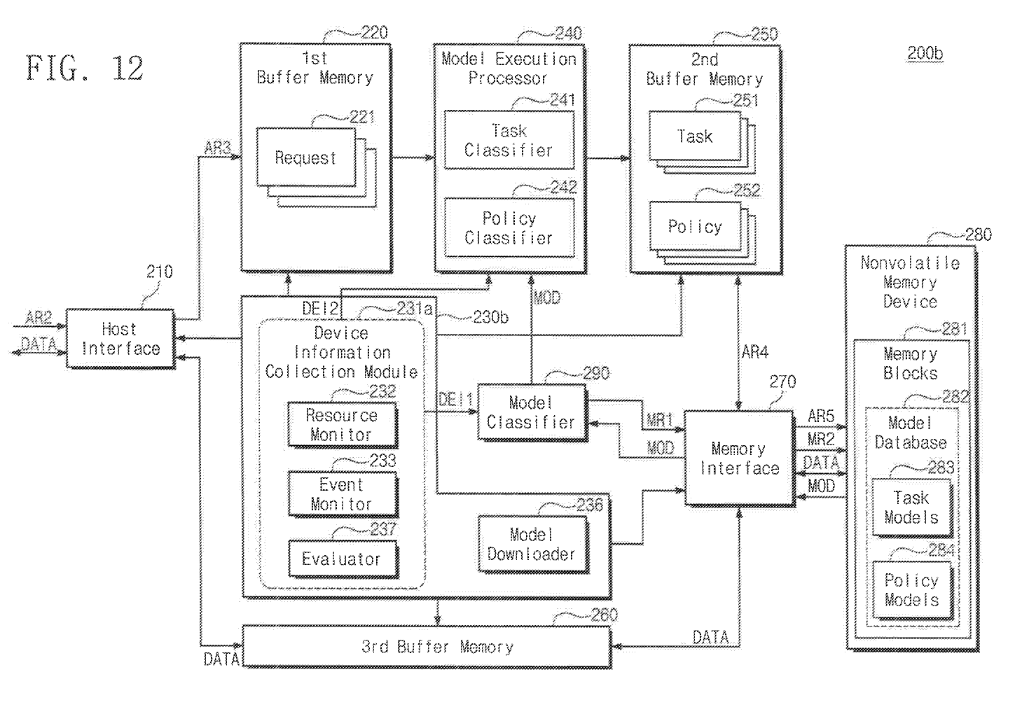

FIG. 12 is a block diagram illustrating a storage device 200b according to another application of the inventive concept. Referring to FIGS. 10 and 12, the storage device 200b includes the host interface 210, the first buffer memory 220, a controller 230b, the model execution processor 240, the second buffer memory 250, the third buffer memory 260, the memory interface 270, the nonvolatile memory device 280, and the model classifier 290.

Compared with the storage device 200a of FIG. 11, the controller 230b has a configuration that differs from the configuration of the controller 230a of FIG. 11 and operates in a different manner than the controller 230a. For example, the controller 230b may further include an evaluator 237. The evaluator 237 may evaluate access operations performed on the basis of a selected model.

For example, the evaluator 237 may evaluate performance such as latencies of access operations. The evaluator 237 may send the evaluation result to the model classifier 290 after including the evaluation result in the first device environment information DEI1 The evaluator 237 may include the evaluation result in the second device environment information DEI2 before being transmitted to the model execution processor 240.

For example, the evaluator 237 may perform an evaluation after the model is selected and a specific time elapses or after the model is selected and a specific number of access operations are performed and include the evaluation result in the device environment information DEI. For example, the evaluator 237 may perform an evaluation after the model is selected and at least one of a read operation, a write operation, and an erase operation or each of the read operation, the write operation, and the erase operation is performed as much as at least the specific number of times and may provide the evaluation result.

The model classifier 290 may further perform classification on the basis of the evaluation result. On the basis of the evaluation result, the model classifier 290 may maintain a current model or may request replacement of the current model with a new model. The model execution processor 240 may schedule the following tasks or policies based on the evaluation result.

For example, in the case where a current model is maintained, the model execution processor 240 may apply the evaluation result. In the case where the current model is changed to a new model, the evaluation result is not associated with the new model. Accordingly, in the case where the current model is changed to the new model, the model execution processor 240 does not apply the evaluation result.

For example, the model classifier 290 may apply the evaluation result after the model is selected and a specific time elapses or after the model is selected and a specific number of access operations are performed. For example, the model classifier 290 may apply the evaluation result after the model is selected and at least one of a read operation, a write operation, and an erase operation or each of the read operation, the write operation, and the erase operation is performed as much as at least the specific number of times.

As described above, the storage device 200b may select and execute a model without intervention of the host device 100b. Also, the storage device 200b may evaluate a model without intervention of the host device 100b and may replace or maintain a model depending on the evaluation result. Accordingly, the storage device 200b optimized to a use pattern of a user based on the machine learning is provided.

According to at least one embodiment of the inventive concept, a method in which a controller accesses a nonvolatile memory device is adjusted according to machine learning. Accordingly, a storage device that provides optimum operating performance to each user, a computing system including the storage device, and an operating method of the storage device are provided.

While the inventive concept has been described with reference to exemplary embodiments thereof, it will be apparent to those of ordinary skill in the art that various changes and modifications may be made thereto without departing from the spirit and scope of the inventive concept.

What is claimed is:

1. A storage device comprising:
a nonvolatile memory device comprising a plurality of first memory blocks to store a plurality of machine learning-based models and a plurality of second memory blocks configured to store user data;
a controller configured to select one of the machine learning-based models stored in the nonvolatile memory based on a model selection request;
a processor configured to load model data associated with the selected model and to schedule a task associated with the nonvolatile memory device based on the loaded model data; and
a memory interface configured to access the second memory blocks of the nonvolatile memory device based on the scheduled task.

2. The storage device of claim 1, wherein the model selection request is transmitted from a host device external to the storage device.

3. The storage device of claim 1, wherein the controller receives new model data received from a host device external to the storage device and stores the received new model data in the first memory blocks through the memory interface.

4. The storage device of claim 1, wherein the controller is configured to generate device environment information indicating resources of the storage device and events that have occurred in the storage device and to send the generated device environment information to the processor, and wherein the processor schedules the task based on the device environment information.

5. The storage device of claim 4, wherein the controller generates the device environment information from at least one of a number of single level cell free memory blocks, a number of multi-level cell free memory blocks, a number of triple level cell free memory blocks, a ratio of valid data stored in single level cells, a ratio of valid data stored in multi-level cells, a ratio of valid data stored in triple level cells, an erase count of the single level cell free memory blocks, an erase count of the multi-level cell free memory blocks, an erase count of the triple level cell free memory blocks, and a residual ratio of a buffer memory.

6. The storage device of claim 4, wherein the controller generates the device environment information from at least one of a number of read commands pending, a number of write commands pending, a number of trim commands pending, or information indicating whether a program error occurs, whether a read error occurs, whether there is a need for a read refresh operation, whether there is a need for wear-leveling management, and whether an idle time exists.

7. The storage device of claim 1, further comprising:
a buffer memory configured to store commands received from a host device external to the storage device, and
wherein the processor selects the task to be scheduled according to at least one of the commands stored in the buffer memory.

8. The storage device of claim 7, wherein the scheduled task is a foreground or a background task for managing the nonvolatile memory device.

9. The storage device of claim 1, wherein the scheduled task is a read operation, a write operation, a trim operation, a garbage collection operation, a data scrubbing operation, a data refresh operation, a wear-leveling management operation, an exception processing operation, or a data transfer operation.

10. The storage device of claim 1, wherein the machine learning-based models include at least one of a performance-centered model, a power-centered model, and a reliability-centered model.

11. The storage device of claim 1, wherein the processor further schedules a policy corresponding to the task, and
wherein the memory interface accesses the second memory blocks of the nonvolatile memory device depending on the scheduled task and the scheduled policy.

12. The storage device of claim 11, wherein the policy selects at least one of a single level cell memory block, a multi-level cell memory block, and a triple level cell memory block as a target.

13. The storage device of claim 1,
wherein the controller is configured to generate device environment information indicating resources of the storage device and events that have occurred in the storage device,
wherein the storage device further comprises a model classifier configured to generate the model selection request based on machine learning operating on the device environment information, and
wherein the processor schedules the task based additionally on the device environment information.

14. The storage device of claim 13, wherein the device environment information further indicates suitability of the selected model.

15. A computing system comprising:
a host device; and
a storage device,
wherein the host device comprises a first controller configured to generate host environment information associated with the computing system, to select a model associated with the storage device based on machine learning depending on the host environment information, and to send a model selection request indicating the selected model to the storage device,
wherein the storage device comprises:
a nonvolatile memory comprising a plurality of memory blocks;
a second controller configured to select one of a plurality of machine learning-based models depending on the model selection request; and
a processor configured to execute the selected model to access the nonvolatile memory device.

16. The computing system of claim 15, wherein the first controller generates the host environment information from at least one of settings of a user, power information, an input and output pattern of a specific application or process, and a work load.

17. The computing system of claim 16, wherein the second controller selects the model associated with the storage device by using the settings of the user as a first element, and load prediction derived from the power information, the input and output pattern of the specific application or process, and the work load as a second element.

18. The computing system of claim 16, wherein the host device further comprises a modem configured to receive data for the machine learning and the input and output pattern of the specific application or process from an external device.

19. The computing system of claim 15, wherein the host environment information further indicates suitability of the selected model.

20. An operation method of a storage device, the method comprising:
selecting, by a controller of the storage device, an operating model of the storage device generated from a first machine learning operation;
receiving, by the controller, a request to access the storage device from an external host device;
scheduling, by the controller, a task to be performed on the storage device based on a second machine learning operation that considers the access request and the selected operating model; and executing, by a processor of the storage device, the scheduled task.
